(19) United States
(12) Patent Application Publication
(10) Pub. No.: US 2007/0112069 A1
(43) Pub. Date: May 17, 2007

(54) Adjuvant formulation for enhancing the fungicidal efficacy and fungicidal composition containing same

(76) Inventors: Kwang-Yun Cho, Daejeon (KR); Ju-Hyun Yu, daejeon (KR); Gyung-Ja Choi, daejeon (KR); He-Kyoung Lim, daejeon (KR); Kyoung-Soo Jang, daejeon (KR); Bum-Tae Kim, Daejeon (KR); Yong Man YU, Daejeon (KR)

Correspondence Address: ANDERSON, KILL & OLICK, P.C., 1251 AVENUE OF THE AMERICAS, NEW YORK,, NY, 10020-1182, US

(21) Appl. No.: 10/565,286

(22) PCT Filed: Jul. 2, 2004
(86) PCT No.: PCT/KR04/01635

§ 371 Date: Jan. 19, 2006

(30) Foreign Application Priority Data
Jul. 2, 2003 (KR) 10-2003-0044486

(51) Int. Cl. A01N 37/12; A01N 37/18; A01N 37/44

(52) U.S. Cl. 514/534; 514/619

(57) ABSTRACT

Disclosed in this invention is an adjuvant formulation for enhancing the fungicidal efficacy of KNF-1001 or KNF-1002 against plant diseases comprising an adjuvant selected from the group consisting of a polyoxyethylene-based nonionic surfactants which has an aliphatic alcohol, a fatty acid or triacyl glyceride as a lipophilic moiety containing at least 8 carbon atoms and a polyoxyethylene as a hydrophilic moiety having 3 to 25 oxyethylene repeating units, a polyoxyethylene and 25 to 45 oxypropylene repeating units and a mixture thereof, an anionic surfactant selected from the group consisting of sodium dioctyl sulfosuccinate, sodium dodecylbenzenesulfonate and a mixture thereof, and fatty acid alkyl esters having at least 14 carbon atoms. Also disclosed in this invention is a fungicidal composition for enhancing the fungicidal efficacy of KNF-1001 or KNF-1002 against plant diseases, which comprises a selected active compound together with said adjuvant.

### FIELD OF THE INVENTION

The present invention relates to an adjuvant composition for enhancing fungicidal efficacy, in particular an adjuvant composition for enhancing the fungicidal efficacy of methyl (2E)-3-methoxy-2-[2′-[[[3″-(1′″-fluoro-2′″-phenyl-1′″-ethenyloxy)phenyl]methyl]imino]oxy]methylphenyl]propenoate (the compound of formula (I), Korean Patent No. 0311195) or N-methyl (2E)-2-methoxyimino-2-[2′-[[[3″-(1′″-fluoro-2′″-phenyl-1′″-ethenyloxy)phenyl]methylimino]oxy]methylphenyl acetamide (the compound of formula (II), Korean Patent No. 0311195) against plant diseases and a fungicidal composition containing same.

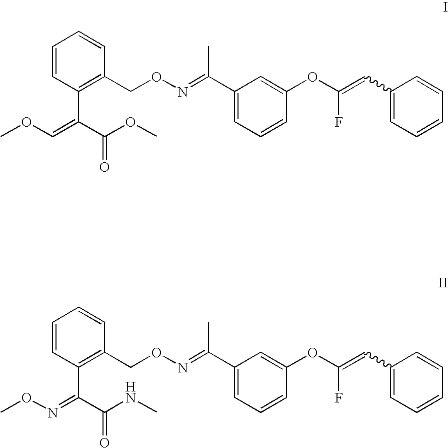

### BACKGROUND OF THE INVENTION

The continuous use of an agrochemical have often induced the appearance of weeds, plant diseases and insects pests which are resistant to once effective agrochemicals, and the application of ever increasing amounts of agrochemicals to control such resistant pests have caused a serious environmental issue. Accordingly, it is required to reduce the application rates of conventional agrochemicals by way of improving, for instance, formulation efficacy through the addition of effective adjuvant thereto.

Such adjuvant used to enhance the formulation efficacy of agrochemical includes a spreader or spreader-sticker which facilitates the spray deposition and retention of an agrochemical to a target crop, a rainfasting agent for preventing from the loss of an agrochemical due to rainwash, and a penetrant which promote the foliar absorption of an agrochemical by a target crop.

Grayson, et al. have reported that an agrochemical which does not easily penetrate into a leaf, such as dimethomorph, can be more effective in protecting the subject crop from plant pathogens when used in combination with a suitable surfactant (Pesticide Science, 46, 199-213 & 355-359(1996) and EP Patent Publication No. 520585 A1).

Because the most suitable adjuvant to a specific agrochemical, however, may be different from one for other agrochemicals, the careful selection must be carried out based on the measurement of foliar absorption or pesticidal efficacy of individual agrochemicals.

New fungicides of formula (I) or (II) has been proved very effective for protecting crops against plant diseases, e.g., powdery mildew of cucumber and barley, late blight of tomato and pepper, white rot of apple and leaf rust of wheat, but their curative activity is not so good due to the lack of penetrability.

Therefore, there has been existed a need to develop an adjuvant composition for enhancing the fungicidal efficacy of the fungicidal compound of formula (I) or (II) by facilitating the foliar uptake and spray deposition of said agrochemical to crop plants, which is stable when formulated.

### SUMMARY OF THE INVENTION

Accordingly, it is an object of the present invention to provide an adjuvant composition for enhancing the fungicidal efficacy by increasing the foliar uptake and spray deposition of the fungicidal compounds of formula (I) and (II) to crop plants, which is stable when formulated; and a fungicidal composition containing same.

### DETAILED DESCRIPTION OF THE INVENTION

In accordance with one aspect of the present invention, there is provided an adjuvant composition for enhancing the fungicidal efficacy (hereafter, “an adjuvant formulation”) of the fungicidal compound of formula (I) or (II) against plant diseases, which comprises;

(a) an effective amount of one or more adjuvant for enhancing the fungicidal efficacy selected from the group consisting of polyoxyethylene-based nonionic surfactants which has an aliphatic alcohol, a fatty acid or triacyl glyceride as a lipophilic moiety containing at least 8 carbon atoms and a polyoxyethylene as a hydrophilic moiety having 3 to 25 oxyethylene repeating units; a polyoxyethylene-polyoxypropylene block copolymer containing 2 to 40 oxyethylene and 25 to 45 oxypropylene repeating units and a mixture thereof; an anionic surfactant selected from the group consisting of sodium dioctyl sulfosuccinate, sodium dodecylbenzenesulfonate and a mixture thereof; and fatty acid alkyl esters having at least 14 carbon atoms;

(b) an emulsifier or dispersant; and

(c) a carrier.

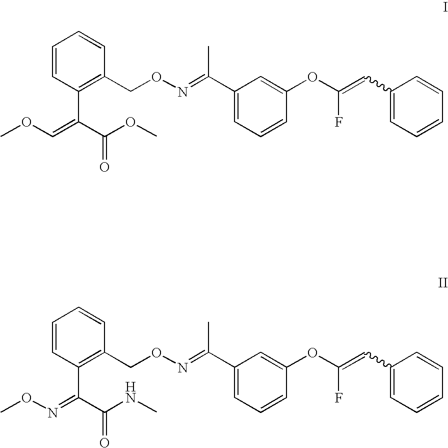

In accordance with another aspect of the present invention, there is provided a fungicidal composition having enhanced fungicidal efficacy (hereafter, “the fungicidal formulation”), which comprises said adjuvant for enhancing the fungicidal efficacy and the fungicidal compound of formula (I) or (II).

The inventive adjuvant for enhancing the fungicidal efficacy increases the fungicidal activity of the agrochemical against plant diseases, e.g., powdery mildew of cucumber and barley, late blight of tomato and pepper and leaf rust of wheat, by way of increasing the foliar uptake and spray deposition of the fungicidal compound of formula (I) (hereafter, “KNF-1001”) or formula (II) (hereafter, “KNF-1002”) by crop plants.

The adjuvant for enhancing the fungicidal efficacy which may be used in the inventive adjuvant formulation is a polyoxyethylene-based nonionic surfactant which has an aliphatic alcohol, an fatty acid or triacyl glyceride as a lipophilic moiety containing at least 8 carbon atoms; a nonionic polyoxyethylene-polyoxypropylene block copolymer surfactant; an anionic surfactant; and a fatty acid ester, e.g., particularly, polyoxyethylene octyl ether, polyoxyethylene decyl ether, polyoxyethylene lauryl ether, polyoxyethylene isododecyl ether, polyoxyethylene tridecyl ether, polyoxyethylene cetyl ether, polyoxyethylene stearyl ether, polyoxyethylene oleyl ether, polyoxyethylene lauryl ester, polyoxyethylene stearyl ester, polyoxyethylene oleyl ester, ethoxylated caster oil and polyoxyethylene coconut fatty ester, wherein the polyoxyethylene moiety has 3 to 25 oxyethylene repeating units; a polyoxyethylene-polyoxypropylene block copolymer containing 2 to 40 oxyethylene and 25 to 45 oxypropylene repeating units; sodium dodecylbenzenesulfonate or sodium dioctyl sulfosuccinate; methyl palmitate, ethyl palmitate, methyl oleate, ethyl oleate, methyl linoleate and ethyl linoleate or a mixture thereof.

The raw material of the synthesis of nonionic surfactant used in the present invention may further comprise an additional aliphatic alcohol or fatty acid. For example, C1012 alcohol may contain 35% decyl alcohol and 52% lauryl alcohol; the lauryl alcohol may further comprise 1% decyl alcohol, 24˜30% cetyl alcohol and less than 5% stearyl alcohol besides 75% lauryl alcohol; the cetyl alcohol may further comprise 10% C₁₂-C₁₄ alcohol and 10% stearyl alcohol besides 80% cetyl alcohol; the stearyl alcohol may further comprise 10% cetyl alcohol and 1% C₁₄ alcohol besides 89% stearyl alcohol; and the oleyl alcohol may be 98% oleyl alcohol.

The foliar uptake and spray deposition of KNF-1001 or KNF-1002 into the plant leaf depends on the number of the oxyethylene or oxypropylene repeating units in the surfactant and the form of formulation. For example, a polyoxyethylene-based surfactant having 3 to 25 oxyethylene repeating units and a polyoxyethylene-polyoxypropylene block copolymer containing 2 to 40 oxyethylene and 25 to 45 oxypropylene repeating units increases the foliar uptake of KNF-1001 or KNF-1002 by the plant. Especially, a polyoxyethylene-based nonionic surfactant having 5 to 20 oxyethylene repeating units and a polyoxyethylene-polyoxypropylene block copolymer containing 4 to 32 oxyethylene and 30 to 35 oxypropylene repeating units significantly facilitate the foliar uptake of the KNF-1001 or KNF-1002 by the plant.

The adjuvant for enhancing the fungicidal efficacy of KNF-1001 or KNF-1002 may be formulated by itself (e.g., an adjuvant formulation) to be applied together with agrochemical formulation to a crop plant, or may be mixed with an agrochemical, an emulsifier or a dispersant, and a carrier (one-pack formulation, e.g., a fungicidal formulation) in accordance with any of the conventional procedures to prepare the various forms of formulation such as solution, powder, pellet, granule and the like.

The content of the adjuvant for enhancing the fungicidal efficacy in the inventive adjuvant formulation ranges from 1 to 98 wt %, preferably 10 to 80 wt % based on the total weight of the composition in consideration of the dilution rate and stability of the formulation.

Further, the content of the adjuvant for enhancing the fungicidal efficacy in the inventive fungicidal formulation ranges from 10 to 80 wt % based on the total weight of the composition, and the amount of the KNF-1001 or KNF-1002 in said formulation of the present invention ranges from 2 to 40 wt % based on the total weight of the composition. The KNF-1001 or KNF-1002 and the adjuvant for enhancing the fungicidal efficacy may be mixed in the range from 1:0.5 to 1:20 by weight.

The inventive adjuvant and the fungicidal compositions may be formulated in accordance with any of the conventional procedures to prepare the various types of formulation such as solution, suspension, emulsion, powder, granule, pellet and the like.

Examples of suitable solvents that may be used in preparing a liquid formulation are water, a water-soluble organic solvent, a water-miscible organic solvent, a water-insoluble organic solvent and the like, e.g., water, methanol, ethanol, isopropyl alcohol, propylene glycol monomethyl ether, N-methyl-2-pyrrolidone, N-octyl-2-pyrrolidone, a substituted benzene-based solvent, mixed xylene and a substituted naphthalene-based solvent.

Examples of suitable carriers that may be used in preparing a solid formulation are a natural or synthetic mineral material, a water-soluble natural or synthetic polymer and the like, e.g., a synthetic silica, diatomite, talc, pyrophilite, kaoline, calcium carbonate, anhydrous sodium sulfate, starch, xanthan gum and carboxymethylcellulose.

In order to improve the physical properties of the formulation, the formulation may additionally include filler, anti-caking agent, lubricating agent, wetting agent, flavoring agent, emulsifier, preservative and the like within the scope without adversely affecting the foliar uptake and spray deposition of KNF-1001 or KNF-1002 by crop plants. Exemplary emulsifier which may be used in the present invention is polyoxyethylene tristyrylphenyl ether, calcium dodecylbenzenesulfonate and a mixture thereof.

Further, the formulation may further comprise another agrochemical for preventing crops from plant diseases besides KNF-1001 or KNF-1002 to prepare a combination product having the activities of both KNF-1001 or KNF-1002 and another agrochemical. The additional agrochemical which may be suitably used in the present invention may be any agrochemical without a special limitation.

The adjuvant for enhancing the fungicidal efficacy may be sprayed in concentration of higher than 50 mg/l together KNF-1001 or KNF-1002 to a crop plant and the concentrations can be increased up to the range where no adverse effect against the plant are observed (approximately 500 to 2,000 mg/l).

The inventive adjuvant formulation brings about an economic benefit by reducing the application rate of KNF-1001 or KNF-1002 to plants due to increases of the foliar uptake and spray deposition of KNF-1001 or KNF-1002.

The following examples are intended to further illustrate the present invention without limiting its scope.

In the following examples, OCE means polyoxyethylene octyl ether; C1012, a mixture of polyoxyethylene decyl ether and polyoxyethylene lauryl ether; DE, polyoxyethylene decyl ether; LE, polyoxyethylene lauryl ether; IDE, polyoxyethylene isododecyl ether; TDE is polyoxyethylene tridecyl ether; CE, polyoxyethylene cetyl ether; SE, polyoxyethylene stearyl ether; OE, polyoxyethylene oleyl ether; LA, polyoxyethylene monolaurate; SA, polyoxyethylene monostearate; OA, polyoxyethylene monooleate; CO, ethoxylated caster oil; and CFA, polyoxyethylene coconut fatty ester, while the number attached on said abbreviation represents the number of oxyethylene repeating units.

Further, Koremul PE-61, Koremul RPE-8020 and Koremul PE-74 used in Examples are polyoxyethylene-polyoxypropylene block copolymers containing 2 to 35 oxyethylene and 25 to 40 oxypropylene repeating units, which are commercially available from Hannong Chemicals Inc. (Korea). In particular, Koremul PE-61 is a polyoxyethylene-polyoxypropylene block copolymer containing 4.4 oxyethylene and 30 oxypropylene repeating units; Koremul RPE-8020 is a polyoxyethylene-polyoxypropylene block copolymer containing 13 oxyethylene and 30 oxypropylene repeating units; and Koremul PE-74 is a polyoxyethylene-polyoxypropylene block copolymer containing 31 oxyethylene and 35 oxypropylene repeating units. Moreover, NaDBS, SDSS, PAM, PAE, STE, OLM, OLE, LIM and LIE mean sodium dodecylbenzenesulfonate, sodium dioctyl sulfosuccinate, methyl palmitate, ethyl palmitate, ethyl stearate, methyl oleate, ethyl oleate, methyl linoleate and ethyl linoleate, respectively.

### EXAMPLE 1

### Preparation of Adjuvant Formulation for Enhancing the Fungicidal Efficacy of Compound of Formula (I) (KNF-1001) or Formula (II) (KNF-1002)

An adjuvant formulation was prepared by dissolving each of the adjuvant for enhancing the fungicidal efficacy listed in Tables 1 to 5 in isopropyl alcohol (hereafter “IPA”) or a substituted benzene-based solvent, e.g., Kocosol 100 (SK Corporation, Korea). When needed, a mixture of polyoxyethylene tristyrylphenyl ether (hereafter “TSP”) and calcium dodecylbenzenesulfonate, as an emulsifier, was further added to the formulation thus obtained.

Adjuvant formulation (0.2 g) thus obtained was added dropwise to 200 ml of hard water (3 degree) and the resulting solution was stirred with a glass rod to observe the diluted state. The stability of the adjuvant formulation thus obtained was observed one year after storing at room temperature.

TABLE 1

| | Composition of adjuvant formulation (weight %) | | | | | | | | |
|---|---|---|---|---|---|---|---|---|---|
| | No. A1 | No. A2 | No. A3 | No. A4 | No. A5 | No. A6 | No. A7 | No. A8 | No. A9 |
| Adjuvant | 70 | 70 | 70 | 50 | 40 | 20 | 70 | 50 | 50 |
| | (OCE-5) | (C1012-7) | (LE-5) | (LE-7) | (LE-9) | (LE-20) | (IDE-5) | (IDE-7) | (IDE-10) |
| Solvent (IPA) | 30 | 30 | 30 | 50 | 60 | 80 | 30 | 50 | 50 |
| Stability¹ | stable | stable | stable | stable | stable | stable | stable | stable | stable |
| Diluted state | solution | solution | solution | solution | solution | solution | solution | solution | solution |

¹formulation stability after 1 year

TABLE 2

| | Composition of adjuvant formulation (weight %) | | | | | | | |
|---|---|---|---|---|---|---|---|---|
| | No. A10 | No. A11 | No. A12 | No. A13 | No. A14 | No. A15 | No. A16 | No. A17 |
| Adjuvant | 70 | 50 | 50 | 50 | 20 | 30 | 30 | 30 |
| | (TDE-5) | (TDE-7) | (TDE-10) | (TDE-15) | (CE-7) | (CE-12) | (CE-20) | (SE-7) |
| Solvent (IPA) | 30 | 50 | 50 | 50 | 80 | 70 | 70 | 70 |
| Stability¹ | stable | stable | stable | stable | stable | stable | stable | stable |
| Diluted state | solution | solution | solution | solution | emulsion | solution | solution | emulsion |

¹formulation stability after 1 year

TABLE 3

| | Composition of adjuvant formulation (weight %) | | | | | | |
|---|---|---|---|---|---|---|---|
| | No. A18 | No. A19 | No. A20 | No. A21 | No. A22 | No. A23 | No. A24 |
| Adjuvant | 30 | 30 | 30 | 50 | 50 | 30 | 50 |
| | (SE-10) | (SE-14) | (SE-20) | (OE-7) | (OE-10) | (OE-20) | (Koremul PE-61) |
| Solvent (IPA) | 70 | 70 | 70 | 50 | 50 | 70 | 50 |
| Stability¹ | stable | stable | stable | stable | stable | stable | stable |
| Diluted state | solution | solution | solution | solution | solution | solution | solution |

¹formulation stability after 1 year

TABLE 4

| | Composition of adjuvant formulation (weight %) | | | | | | | |
|---|---|---|---|---|---|---|---|---|
| | No. A25 | No. A26 | No. A27 | No. A28 | No. A29 | No. A30 | No. A31 | No. A32 |
| Adjuvant | 50 | 50 | 50 | 50 | 50 | 50 | 50 | 50 |
| | (Koremul | (Koremul RPE- | (LA-9) | (SA-9) | (OA-9) | (CFA-9) | (SDSS) | (NaDBS) |
| | PE-74) | 8020) | | | | | | |
| Solvent | 50 | 50 | 50 | 50 | 50 | 50 | 25 | 25 |
| | (IPA) | (IPA) | (IPA) | (IPA) | (IPA) | (IPA) | (IPA) | (methanol) |
| | | | | | | | 25 | 25 |
| | | | | | | | (water) | (water) |
| Stability¹ | stable | stable | stable | stable | stable | stable | stable | stable |
| Diluted state | solution | solution | solution | solution | solution | solution | solution | solution |

¹formulation stability after 1 year

TABLE 5

| | Composition of adjuvant formulation (weight %) | | | | |
|---|---|---|---|---|---|
| | No. A33 | No. A34 | No. A35 | No. A36 | No. A37 |
| Adjuvant | 30 | 30 | 50 | 50 | 50 |
| | (PAE) | (STE^{b}) | (OLM) | (LIM) | (CO-17) |
| Emulsifier^{a} | 10 | 10 | 10 | 10 | — |
| Solvent | 60 | 60 | 40 | 40 | 50 |
| | (K 100^{c}) | (K 100) | (K 100) | (K 100) | (IPA) |
| Stability | stable | stable | stable | stable | stable |
| Diluted state | emulsion | emulsion | emulsion | emulsion | solution |

^{a}emulsifier: a mixture of polyoxyethylene tristyryl phenyl ether and calcium dodecylbenzenesulfonate
^{b}ethyl stearate
^{c}Kocosol 100 (SK Corporation, Korea.)

### EXAMPLE 2

### Preparation of Fungicidal Formulation Containing KNF-1002 and the Adjuvant for Enhancing the Fungicidal Efficacy

KNF-1002 (purity 94%) and the adjuvant for enhancing the fungicidal efficacy listed in Tables 6 to 11 were dissolved in propylene glycol monomethyl ether (hereafter “PGME”) or Kocosol 100 to obtain a fungicidal formulation containing KNF-1002 and adjuvant.

Formulation (0.2 g) thus obtained was added dropwise to 200 ml of hard water (3 degree) and the resulting solution was stirred with a glass rod to observe the diluted state. The stability of the composition thus obtained was observed one year after storing at room temperature.

TABLE 6

| | Composition of fungicidal formulation (weight %) | | | | | | | | |
|---|---|---|---|---|---|---|---|---|---|
| | No. F1 | No. F2 | No. F3 | No. F4 | No. F5 | No. F6 | No. F7 | No. F8 | No. F9 |
| KNF- | 10.7 | 10.7 | 10.7 | 10.7 | 10.7 | 10.7 | 10.7 | 10.7 | 10.7 |
| 1002 | | | | | | | | | |
| Adjuvant | 40 | 40 | 20 | 40 | 50 | 40 | 10 | 20 | 40 |
| | (OCE-7) | (C1012-7) | (LE-5) | (LE-5) | (LE-5) | (LE-7) | (LE-9) | (LE-9) | (LE-9) |
| Solvent | 49.3 | 49.3 | 69.3 | 49.3 | 39.3 | 49.3 | 79.3 | 69.3 | 49.3 |
| Stability | stable | stable | stable | stable | stable | stable | stable | stable | stable |
| Diluted | emulsion | emulsion | emulsion | emulsion | emulsion | emulsion | emulsion | emulsion | emulsion |
| state | | | | | | | | | |

TABLE 7

| | Composition of fungicidal formulation (weight %) | | | | | | | |
|---|---|---|---|---|---|---|---|---|
| | No. F10 | No. F11 | No. F12 | No. F13 | No. F14 | No. F15 | No. F16 | No. F17 |
| KNF-1002 | 5.4 | 10.7 | 10.7 | 10.7 | 10.7 | 10.7 | 10.7 | 10.7 |
| Adjuvant | 40 | 40 | 40 | 40 | 40 | 40 | 40 | 40 |
| | (LE-9) | (LE-20) | (IDE-5) | (IDE-7) | (IDE-10) | (TDE-5) | (TDE-7) | (TDE-10) |
| Solvent (IPA) | 54.6 | 49.3 | 49.3 | 49.3 | 49.3 | 49.3 | 49.3 | 49.3 |
| Stability | stable | stable | Stable | stable | stable | stable | stable | stable |
| Diluted state | emulsion | emulsion | emulsion | emulsion | emulsion | emulsion | emulsion | emulsion |

TABLE 8

| | Composition of fungicidal formulation (weight %) | | | | | | | |
|---|---|---|---|---|---|---|---|---|
| | No. F18 | No. F19 | No. F20 | No. F21 | No. F22 | No. F23 | No. F24 | No. F25 |
| KNF-1002 | 10.7 | 10.7 | 10.7 | 10.7 | 10.7 | 10.7 | 10.7 | 10.7 |
| Adjuvant | 40 | 40 | 40 | 40 | 40 | 40 | 40 | 40 |
| | (TDE-15) | (CE-7) | (CE-12) | (CE-20) | (SE-7) | (SE-10) | (SE-14) | (SE-20) |
| Solvent | 49.3 | 49.3 | 49.3 | 49.3 | 49.3 | 49.3 | 49.3 | 49.3 |
| (PGME) | | | | | | | | |
| Stability | stable | stable | stable | stable | stable | stable | stable | stable |
| Diluted state | emulsion | emulsion | emulsion | emulsion | emulsion | emulsion | emulsion | emulsion |

TABLE 9

| | Composition of fungicidal formulation (weight %) | | | | | | | |
|---|---|---|---|---|---|---|---|---|
| | No. F26 | No. F27 | No. F28 | No. F29 | No. F30 | No. F31 | No. F32 | No. F33 |
| KNF-1002 | 10.7 | 10.7 | 10.7 | 10.7 | 10.7 | 10.7 | 10.7 | 10.7 |
| Adjuvant | 40 | 40 | 40 | 40 | 40 | 60 | 40 | 40 |
| | (OE-7) | (OE-10) | (OE-20) | (PE-61^{a}) | (PE-74^{b}) | (PE-74^{b}) | (RPE-8020^{c}) | (LA-9) |
| Emulsifier | — | — | — | 10 | — | — | 10 | — |
| | | | | (TSP^{d}) | | | (TSP) | |
| Solvent | 49.3 | 49.3 | 49.3 | 49.3 | 49.3 | 29.3 | 49.3 | 49.3 |
| (PGME) | | | | | | | | |
| Stability | stable | stable | stable | stable | stable | stable | stable | stable |
| Diluted state | emulsion | emulsion | emulsion | emulsion | emulsion | emulsion | emulsion | emulsion |

^{a}Koremul PE-61
^{b}Koremul PE-74
^{c}Koremul RPE-8020
^{d}polyoxyethylene tristyryl phenyl ether

TABLE 10

| | Composition of fungicidal formulation (weight %) | | | | | | | |
|---|---|---|---|---|---|---|---|---|
| | No. F34 | No. F35 | No. F36 | No. F37 | No. F38 | No. F39 | No. F40 | No. F41 |
| KNF-1002 | 10.7 | 10.7 | 10.7 | 10.7 | 10.7 | 10.7 | 10.7 | 10.7 |
| Adjuvant | 40 | 40 | 40 | 40 | 40 | 40 | 40 | 40 |
| | (SA-9) | (OA-9) | (SDSS) | (NaDBS) | (PAE) | (STE^{c}) | (OLM) | (LIM) |
| Emulsifier^{a} | — | — | — | — | 10 | 10 | 10 | 10 |
| Solvent (PGME) | 49.3 | 49.3 | 49.3 | 49.3 | 39.3 | 39.3 | 39.3 | 39.3 |
| | (PGME) | (PGME) | (PGME) | (PGME) | (K 100^{b}) | (K 100) | (K 100) | (K 100) |
| Stability | stable | stable | stable | stable | stable | stable | stable | stable |
| Diluted state | emulsion | emulsion | emulsion | emulsion | emulsion | emulsion | emulsion | emulsion |

^{a}emulsifier: a mixture of polyoxyethylene tristyryl phenyl ether and calcium dodecylbenzenesulfonate
^{b}Kocosol 100 (SK Corporation, Korea)
^{c}ethyl stearate

TABLE 11

| | Composition of fungicidal formulation (weight %) | | | | | |
|---|---|---|---|---|---|---|
| | No. F42 | No. F43 | No. F44 | No. F45 | No. F46 | No. F47 |
| KNF-1002 | 10.7 | 10.7 | 10.7 | 10.7 | 10.7 | 10.7 |
| Adjuvant | 40 | 40 | 40 | 40 | 40 | 40 |
| | (LE-9) | (CE-12) | (SE-14) | (OE-10) | (Koremul PE-74) | (CO-17) |
| Solvent | 29.3 | 29.3 | 29.3 | 29.3 | 29.3 | 49.3 |
| | (PGME) | (PGME) | (PGME) | (PGME) | (PGME) | (PGME) |
| | 20.0 | 20.0 | 20.0 | 20.0 | 20.0 | |
| | (water) | (water) | (water) | (water) | (water) | |
| Stability | stable | stable | stable | stable | stable | stable |
| Diluted state | emulsion | emulsion | emulsion | emulsion | emulsion | solution |

### EXAMPLE 3

### Preparation of KNF-1001 and KNF-1002 Formulation Containing No Adjuvant for Enhancing the Fungicidal Efficacy as a Control Formulation

KNF-1001 (purity 94%) or KNF-1002 (purity 94%) was melted, and a powdered synthetic silica (Zeosil 39) was added thereto and then the resulting mixture was powdered.

Polyoxyethylene nonylphenyl sulfonate, polyoxyethylene nonylphenyl ether and a powdered synthetic silica were mixed in a ratio of 3:2:5 and then, the resulting mixture was powdered to prepare a dispersant.

The powdered agrochemical, dispersant and kaoline as shown in Table 12, were mixed and powdered to obtain a fungicidal formulation as a wettable powder (WP).

Further, the fungicidal emulsifiable concentrate (EC) was prepared by dissolving KNF-1001 (purity 94%) or KNF-1002 (purity 94%) and TSP in PGME as listed in Table 12.

TABLE 12

| | Composition of fungicidal formulation | | | |
|---|---|---|---|---|
| | as a control (weight %) | | | |
| | KNF-1001 | KNF-1002 | KNF-1001 | KNF-1002 |
| Component | WP | WP | EC | EC |
| Agrochemical | 21.4 | 21.4 | 21.4 | 21.4 |
| Surfactant | 10.0 | 5.0 | 10.0 | 10.0 |
| | (dispersant) | (dispersant) | (TSP) | (TSP) |
| Carrier | 25.0 | 25.0 | 68.6 | 68.6 |
| | (Zeosil 39) | (Zeosil 39) | | |
| | 43.6 (kaoline) | 43.6 (kaoline) | (PGME) | (PGME) |
| Stability | stable | stable | stable | stable |
| Diluted state | suspension | suspension | emulsion | emulsion |

### TEST EXAMPLE 1

### Phytotoxicity of Adjuvant to Cucumber Plants

Cucumber plants (Cucumis sativus L, cv Baekmi Baekdadagi, Dongbu Hannonng Seeds Co, Ltd, Korea) were grown on to the four- to five-leaf stage in the glasshouse.

Each adjuvant formulation obtained in Example 1 was dissolved in distilled water to a concentration of 1,000 mg/i and 500 mg/l respectively. Aqueous solutions of adjuvant formulations were applied to five cucumber plants to run-off using a hydraulic hand-held sprayer. Phytotoxicity was assessed visually on week after spraying, and the result is shown in Table 13.

TABLE 13

Phytotoxicity to
cucumber plant

| Adjuvant formulation | 1,000 mg/l | 500 mg/l |
|---|---|---|
| OCE-5 (No. A1) | 0 | 0 |
| C1012-7 (No. A2) | 0 | 0 |
| LE-5 (No. A3) | 0 | 0 |
| LE-7 (No. A4) | 0 | 0 |
| IDE-7 (No. A8) | 0.5 | 0 |
| TDE-7 (No. A11) | 0 | 0 |
| CE-12 (No. A15) | 0.25 | 0 |
| SE-10 (No. A18) | 0 | 0 |
| OE-7 (No. A21) | 0.25 | 0 |
| OE-10 (No. A22) | 0 | 0 |
| OE-20 (No. A23) | 0.75 | 0 |
| LA-9 (No. A27) | 0 | 0 |
| SA-9 (No. A28) | 0.5 | 0 |
| OA-9 (No. A29) | 0 | 0 |
| CFA-9 (No. A30) | 0 | 0 |
| SDSS (No. A31) | 0.5 | 0 |
| NaDBS (No. A32) | 0 | 0 |
| CO-17 (No. A37) | 0 | 0 |

0: no phytotoxicity,
1: only negligible phytotoxicity which did not affect the growth, and
2 to 4: increasing phytotoxicity and growth inhibition,
5: death

As can be seen from Table 13, the inventive adjuvant formulation showed little phytotoxicity at both concentrations of 500 mg/l and 1,000 mg/l.

### TEST EXAMPLE 2

### Foliar Uptake of KNF-1001 into Cucumber Plant 24 Hours after Spraying of Aqueous Suspension Containing Adjuvant

KNF-1001 WP obtained in Example 3 was diluted with water. Adjuvant formulations obtained in Example 1 and an aqueous Congo Red solution as a tracer were added so that the final concentrations of adjuvant and KNF-1001 became 500 mg/l and 50 mg/l, respectively, while adjusting the Congo Red concentration to 50 mg/l. A control spray suspension containing KNF-1001 WP alone was also prepared.

Cucumber plants were grown on to the four- to five-leaf stage in the glasshouse. Only the second leaf of cucumber plant was used for all tests. Aqueous suspensions of KNF-1001 WP were sprayed onto 10 cucumber plants and 10 glass plates (10 cm×10 cm) at a rate equivalent to 100 l/ha in a spray booth (model SP-6, 8001 EVB nozzle, R&D Sprayers Inc., USA).

Immediately after spraying, five cucumber leaves and 5 glass plates were washed with aqueous acetonitrile solution (acetonitrile/water=7/3, v/v, 15 ml) for 2 minutes. The remainder of the cucumber plants and glass plates were stored in a dark room (temperature; 23-26° C., relative humidity; 81-94%), and washed after 24 hours.

Congo Red and KNF-1001 contents in washings were analyzed by HPLC (high performance liquid chromatography). Foliar uptake of the fungicide was calculated in accordance with the method as described in KR Patent No. 0314600.

The result is shown in Table 14.

TABLE 14

| Adjuvant | Foliar uptake of KNF-1001 into |
|---|---|
| formulation No. | cucumber plant (%) |
| OCE-5 (No. A1) | 21.3 |
| C1012-7 (No. A2) | 46.9 |
| LE-5 (No. A3) | 58.4 |
| LE-7 (No. A4) | 53.0 |
| LE-9 (No. A5) | 30.2 |
| LE-20 (No. A6) | 33.2 |
| IDE-7 (No. A8) | 56.1 |
| TDE-7 (No. A11) | 50.3 |
| CE-7 (No. A14) | 63.8 |
| CE-12 (No. A15) | 48.4 |
| CE-20 (No. A16) | 32.8 |
| SE-7 (No. A17) | 30.7 |
| SE-10 (No. A18) | 31.8 |
| SE-14 (No. A19) | 45.6 |
| SE-20 (No. A20) | 49.2 |
| OE-7 (No. A21) | 68.9 |
| OE-10 (No. A22) | 57.0 |
| OE-20 (No. A23) | 35.2 |
| LA-9 (No. A27) | 29.3 |
| SA-9 (No. A28) | 33.5 |
| OA-9 (No. A29) | 34.7 |
| CFA-9 (No. A30) | 30.4 |
| SDSS (No. A31) | 45.7 |
| NaDBS (No. A32) | 51.5 |
| CO-17 (No. A37) | 12.3 |
| No adjuvant (control) | 6.9 |
| Glass plate | 0.0 |

As shown in Table 14, no dissipation of KNF-1001 was observed even on the glass plate 24 hours after spraying. In the absence of adjuvant only 6.9% of the applied KNF-1001 was absorbed into cucumber leaves 24 hours after spraying with an aqueous WP suspension. After adding adjuvant, uptake could be increased up to 68.9%. Uptake enhancement followed the general order OE-7<CE-7<OE-10.

### TEST EXAMPLE 3

### Foliar Uptake of KNF-1001 into Cucumber Plant 48 Hours after Spraying of Aqueous Emulsion Containing Adjuvant

KNF-1001 EC obtained in Example 3 was diluted with water. Adjuvant formulations obtained in Example 1 and an aqueous Congo Red solution as a tracer were added so that the final concentrations of adjuvant and KNF-1001 became 500 mg/l and 100 mg/l, respectively, while adjusting the Congo Red concentration to 25 mg/l. A control spray solution containing only KNF-1001 EC was also prepared.

Cucumber plants were grown on to the four- to five-leaf stage in the glasshouse. Only the second leaf of cucumber plant was used for all tests. Aqueous emulsions of KNF-1001 EC were sprayed onto 10 cucumber plants at a rate equivalent to 100 l/ha in a spray booth.

Immediately after spraying, five cucumber leaves were washed with aqueous acetonitrile solution (acetonitrile/water=7/3, v/v, 15ml) for 2 minutes. The remainder of the cucumber plants was stored in a dark room (temperature; 23-26° C., relative humidity; 75-81%), and washed after 48 hours.

Congo Red and KNF-1001 contents in washings were analyzed by HPLC (high performance liquid chromatography). Foliar uptake of the fungicide was calculated in accordance with the method as described in KR Patent No. 0314600.

The result is shown in Table 15.

TABLE 15

| | Foliar uptake of KNF-1001 |
|---|---|
| Adjuvant formulation No. | into cucumber plant (%) |
| LE-5 (No. A3) | 20.9 |
| LE-9 (No. A5) | 21.1 |
| LE-20 (No. A6) | 13.8 |
| CE-7 (No. A14) | 35.4 |
| CE-12 (No. A15) | 33.7 |
| CE-20 (No. A16) | 11.4 |
| SE-7 (No. A17) | 0.3 |
| SE-10 (No. A18) | 22.4 |
| SE-14 (No. A19) | 25.1 |
| SE-20 (No. A20) | 21.0 |
| OE-7 (No. A21) | 24.5 |
| OE-10 (No. A22) | 25.8 |
| OE-20 (No. A23) | 16.4 |
| No adjuvant (control) | 3.5 |

In the absence of adjuvant, only 3.5% of the applied KNF-1001 was absorbed by cucumber plant 48 hours after spraying with an aqueous emulsion. After adding adjuvant, uptake could be increased up to 35.4%. Uptake enhancement followed the general order CE-7<CE-12<OE-10.

### TEST EXAMPLE 4

### Fungicidal Activity of INF-1001 WP Against Cucumber Powdery Mildew by Adjuvant Formulation

Cucumber plants were grown from seed to the one-leaf stage. Each cucumber plant was transplanted into Wagner pots (1/5,000 are) filled with fertilized commercial soil, and grown to the five- to six-leaf stage under glasshouse conditions while infected with Sphaerotheca fuliginea naturally.

Spray suspensions were prepared containing KNF-1001 WP 100mg ai/l (obtained in Example 3), CE-7 adjuvant formulation 200 mg/l, 400 mg/l and 800 mg/l or CE-12 adjuvant formulation 400 mg/l (obtained in Example 1), respectively. Then, these were further diluted with water to prepare an fungicidal formulation containing KNF-1001 at concentrations of 20 mg/l, 4 mg/l and 0.8 mg/l. A spray suspension was also prepared with KNF-1001 WP alone as a control.

Each spray suspension was then sprayed onto five cucumber plants to run-off. The repeating application was conducted 7 days after first spraying. Disease severity was rated 7 days after the second treatment on 10 leaves per plant. The incidence of powdery mildew was evaluated visually on individual leaflets as percentage of infected area, using a 0-4 index.

An infection index was determined as follows:

no spotted area as 0;

1 to 5% of infected area as 1;

5.1 to 20% of infected area as 2;

20.1 to 40% of infected area as 3;

and more than 40.1 % of infected area as 4.

The degree of infection (%) and the fungicidal activity (%) was calculated by the following equations I and II, respectively.

Equation I Degree of infection (%)=(Sum of infection index/4×number of observed leaves)×100

Equation II

$$Fungicidal activity ( \% ) = [ 1 - \frac{\begin{matrix}Degree of infection \\ in treated group\end{matrix}}{\begin{matrix}Degree of infection \\ in non \text{-} treated group\end{matrix}} ] \times 100$$

The result is shown in Table 16.

TABLE 16

| | Fungicidal activity (%) of KNF-1001 | | | | |
|---|---|---|---|---|---|
| | against cucumber powdery mildew | | | | |
| | depending on concentration (mg/l) | | | | |
| Composition | 100 | 20 | 4 | 0.8 | EC₅₀ |
| KNF-1001 + CE-7 (1:8) | 90.4 | 87.9 | 60.2 | 15.9 | 3.74 |
| KNF-1001 + CE-7 (1:4) | 90.0 | 81.0 | 49.1 | 8.3 | 5.92 |
| KNF-1001 + CE-7 (1:2) | 86.2 | 77.8 | 33.2 | 11.7 | 7.83 |
| KNF-1001 + CE-12 (1:4) | 89.2 | 86.5 | 42.5 | 15.5 | 5.36 |
| KNF-1001 (control) | 74.7 | 63.3 | 34.6 | 0.8 | 13.71 |

EC₅₀ (mg/l) is 50% antifungal concentration

As shown in Table 16, the fungicidal formulation comprising the KNF-1001 WP together with adjuvant formulation showed significantly higher fungicidal activity against cucumber powdery mildew than KNF-1001 WP alone. The EC₅₀ value by KNF-1001 WP alone was 13.71 mg/l, while that of experimental group employing CE-7 (No. A14 obtained in Example 1) was so lower as 3.74 mg/l that the fungicidal activity of KNF-1001 by adjuvant was 3.7-fold greater than that of KNF-1001 WP alone. Further, the higher the adjuvant contents in spray suspension increased, the more increased the fungicidal activity against cucumber powdery mildew. And the fungicidal activity of KNF-1001 incorporated with CE-12 was higher than that with CE-7. The result suggested that the addition of adjuvant to KNF-1001 spray suspension increased the foliar uptake of fungicide into cucumber plant to be increased the fungicidal activity against cucumber powdery mildew. Therefore, the use of adjuvant for facilitating the foliar uptake of KNF-1001 into crop plant can enhance the fungicidal activity of KNF-1001.

### TEST EXAMPLE 5

### Fungicidal Activity of KNF-1001 EC Against Cucumber Powdery Mildew by Adjuvant Formulation

Cucumber plants were grown to the five- to six-leaf stage under glasshouse conditions while infected with Sphaerotheca fuliginea naturally.

Spray emulsions were prepared containing KNF-1001 EC 100 mg ai/l (obtained in Example 3), adjuvant formulation 400 mg/l, 1,000 mg/l, respectively. Then, these were further diluted with water to prepare an fungicidal formulation containing KNF-1001 at concentrations of 20 mg/l, 4 mg/l and 0.8 mg/l. A spray emulsion was also prepared with KNF-1001 EC in the absence of adjuvant.

Then, the fungicidal activity was measured in accordance with the procedure as described in Test example 4 and the result is shown in Table 17.

TABLE 17

| | Fungicidal activity (%) of KNF-1001 | | | | |
|---|---|---|---|---|---|
| | against cucumber powdery | | | | |
| | mildew depending on | | | | |
| | concentration (mg/l) | | | | |
| Composition | 100 | 20 | 4 | 0.8 | EC₅₀ |
| KNF-1001 + CE-12 (1:10) | 91 | 89 | 47 | 3.1 | 6.02 |
| KNF-1001 + CE-12 (1:4) | 91 | 73 | 37 | 18 | 6.63 |
| KNF-1001 + LE-5 (1:10) | 96 | 83 | 49 | 33 | 2.92 |
| KNF-1001 + LE-5 (1:4) | 69 | 63 | 58 | 16 | 7.72 |
| KNF-1001 (control) | 62 | 44 | 34 | 10 | 30.05 |

EC₅₀ (mg/l) is 50% antifungal concentration

As shown in Table 17, the fungicidal formulation comprising the 10 KNF-1001 EC together with adjuvant formulation showed significantly higher fungicidal activity against cucumber powdery mildew than KNF-1001 EC alone. The EC₅₀ value by KNF-1001 EC was 30.05 mg/l, while that of experimental group employing LE-5 (No. A3 obtained in Example 1) was so lower as 2.92 mg/l that the fungicidal activity of KNF-1001 by adjuvant was 10.3-fold greater than that of control. The fungicidal activity against cucumber powdery mildew increased with the increase of adjuvant content.

### TEST EXAMPLE 6

### Foliar Uptake of KNF-1002 into Cucumber Plant 48 Hours after Spraying of Aqueous Emulsion Containing Adjuvant

Cucumber plants were grown on to the four- to five-leaf stage in the glasshouse. Only the second leaf of cucumber plant was used for all tests.

KNF-1002 EC obtained in Example 3 was diluted with water.

Adjuvant formulations obtained in Example 1 and an aqueous Congo Red solution as a tracer were added so that the final concentrations of adjuvant and KNF-1002 became 500 mg/l and 100 mg/l, respectively, while adjusting the Congo Red concentration to 25 mg/l. A control spray emulsion containing only KNF-1002 EC was also prepared.

Aqueous emulsions of KNF-1002 EC were sprayed onto 10 cucumber plants and 10 glass plates (10 cm×10 cm) at a rate equivalent to 100 l/ha in a spray booth (model SP-6, 8001 EVB nozzle, R&D Sprayers Inc., USA).

Immediately after spraying, five cucumber leaves and 5 glass plates were washed with aqueous acetonitrile solution (acetonitrile/water=7/3, v/v, 15 ml) for 2 minutes. The remainder of the cucumber plants and glass plates were stored in a dark room (temperature; 24-26° C., relative humidity; 71-83%), and washed after 48 hours.

Congo Red and KNF-1002 contents in washings were analyzed by HPLC (high performance liquid chromatography). The uptake rate of KNF-1002 was calculated in accordance with the method as described in Test example 2.

The result is shown in Table 18.

TABLE 18

| | Foliar uptake of KNF-1002 |
|---|---|
| Adjuvant formulation No. | into cucumber plant (%) |
| OCE-5 (No. A1) | 4.6 |
| C1012-7 (No. A2) | 18.6 |
| LE-5 (No. A3) | 20.0 |
| LE-7 (No. A4) | 25.0 |
| LE-9 (No. A5) | 28.1 |
| LE-20 (No. A6) | 22.5 |
| IDE-7 (No. A8) | 31.5 |
| TDE-7 (No. A11) | 22.3 |
| CE-7 (No. A14) | 73.9 |
| CE-12 (No. A15) | 59.2 |
| CE-20 (No. A16) | 50.5 |
| SE-7 (No. A17) | 21.6 |
| SE-10 (No. A18) | 50.8 |
| SE-14 (No. A19) | 71.6 |
| SE-20 (No. A20) | 58.0 |
| OE-7 (No. A21) | 36.9 |
| OE-10 (No. A22) | 58.0 |
| OE-20 (No. A23) | 44.0 |
| LA-9 (No. A27) | 22.5 |
| SA-9 (No. A28) | 42.2 |
| OA-9 (No. A29) | 48.8 |
| CFA-9 (No. A30) | 19.9 |
| SDSS (No. A31) | 24.1 |
| NaDBS (No. A32) | 6.8 |
| CO-17 (No. A37) | 14.1 |
| No adjuvant (control) | 0.5 |
| Glass Plate | 0.0 |

As shown in Table 18, no dissipation of KNF-1002 was observed even on the glass plate 24 hours after spraying. In the absence of adjuvant only 0.5% of the applied KNF-1002 was absorbed into cucumber leaves 48 hours after spraying with an aqueous emulsion. After adding adjuvant, uptake could be increased up to 73.9%. Uptake enhancement followed the general order CE-7<SE-14<CE-12<OE-10.

### TEST EXAMPLE 7

### Foliar Uptake of KNF-1002 into Cucumber Plant 48 Hours after Spraying of Aqueous Emulsion Containing Fatty Acid Ester as an Adjuvant

The foliar uptake of KNF-1002 EC by the adjuvant listed in Table 19 into cucumber plant was measured by the method as described in Test example 6.

The result is shown in Table 19.

TABLE 19

| | Foliar uptake of KNF-1002 |
|---|---|
| Adjuvant formulation No. | into cucumber plant (%) |
| PAE (No. A32) | 13.3 |
| STE (No. A33) | 0.8 |
| OLM (No. A34) | 13.6 |
| LIM (No. A35) | 17.8 |
| No adjuvant (control) | 0.2 |

As shown in Table 19, the foliar uptake of KNF-1002 into cucumber plant in the absence of adjuvant was only 0.2%, but significantly increased in the presence of adjuvant.

### TEST EXAMPLE 8

### Fungicidal Activity of KNF-1002 EC Against Cucumber Powdery Mildew by Adjuvant Formulation

Cucumber plants were grown to the five- to six-leaf stage under glasshouse conditions while infected with Sphaerotheca fuliginea naturally.

Spray emulsions were prepared containing KNF-1002 EC 100mg ai/l (obtained in Example 3), CE-12 adjuvant formulation 200 mg/l, 500 mg/l or LE-5 adjuvant formulation 200 mg/l, 500 mg/l (obtained in Example 1), respectively. Then, these were further diluted with water to prepare an fungicidal formulation containing KNF-1001 at concentrations of 20 mg/l, 4 mg/l and 0.8 mg/l. A spray emulsion was also prepared with KNF-1002 EC in the absence of adjuvant.

Then, the fungicidal activity was measured in accordance with the procedure as described in Test example 4 and the result is shown in Table 20.

TABLE 20

| | Fungicidal activity (%) of | | | | |
|---|---|---|---|---|---|
| | KNF-1002 against cucumber | | | | |
| | powdery mildew depending | | | | |
| | on concentration (mg/l) | | | | |
| Composition | 100 | 20 | 4 | 0.8 | EC₅₀ |
| KNF-1002 + CE-12 (1:5) | 88 | 85 | 49 | 10 | 4.88 |
| KNF-1002 + CE-12 (1:2) | 91 | 84 | 46 | 8.7 | 5.88 |
| KNF-1002 + LE-5 (1:5) | 96 | 88 | 46 | 18 | 4.44 |
| KNF-1002 + LE-5 (1:2) | 89 | 72 | 44 | 14 | 6.61 |
| KNF-1002 (control) | 61 | 66 | 37 | 17 | 14.38 |

EC₅₀ (mg/l) is 50% antifungal concentration

As shown in Table 20, the fungicidal formulation comprising the KNF-1002 EC together with the adjuvant formulation showed significantly higher fungicidal activity against cucumber powdery mildew than KNF-1002 EC in the absence of adjuvant. The EC₅₀ value by KNF-1002 EC was 14.38 mg/l, while that of experimental group employing LE-5 (No. A3 obtained in Example 1) was so lower as 4.44 mg/l that the fungicidal activity of KNF-1002 by adjuvant was 3.2-fold greater than that of control. The fungicidal activity against cucumber powdery mildew increased with the increase of adjuvant content.

### TEST EXAMPLE 9

### Fungicidal Activity of KNF-1002 EC Against Strobilurin-Resistant Powdery Mildew of Cucumber by Adjuvant Formulation

Cucumber plants were grown to the five- to six-leaf stage under glasshouse conditions while infected with Sphaerotheca fuliginea (Sphaerotheca fusca) naturally.

Spray emulsions were prepared to contain KNF-1002 EC 200mg ai/Q (obtained in Example 3), OE-10 adjuvant formulation 200 mg/l, 400 mg/l, 800 mg/l, 500 mg/l (obtained in Example 1), respectively. Then, these were further diluted with water to prepare an fungicidal formulation containing KNF-1001 at concentrations of 67 mg/l, 22 mg/l, 7.4 mg/l and 2.5 mg/l. A spray emulsion was also prepared with KNF-1002 EC in the absence of adjuvant.

Then, the fungicidal activity was measured in accordance with the procedure as described in Test example 4 and the result is shown in Table 21.

TABLE 21

| | Fungicidal activity (%) of KNF-1002 | | | | | |
|---|---|---|---|---|---|---|
| | against cucumber powdery mildew | | | | | |
| | depending on concentration (mg/l) | | | | | |
| Composition | 200 | 67 | 22 | 7.4 | 2.5 | EC₅₀ |
| KNF-1002 + OE-10 (1:4) | 50 | 46 | 20 | 0 | 0 | 143 |
| KNF-1002 + OE-10 (1:2) | 58 | 33 | 12 | 0 | 0 | 151 |
| KNF-1002 + OE-10 (1:1) | 47 | 25 | 4 | 4 | 1 | 236 |
| KNF-1002 (control) | 23 | 5 | 3 | 2 | 0 | 5361 |

EC₅₀ (mg/l) is 50% antifungal concentration

As shown in Table 21, the fungicidal activity of KNF-1002 in itself against strobilurin-resistant powdery mildew of cucumber was very low. But the fungicidal formulations containing KNF-1002 and adjuvant OE-10 showed significantly higher fungicidal activity against strobilurin-resistant Sphaerotheca fuliginea on cucumber than KNF-1002 without adjuvant. The fungicidal activity increased with the increase of adjuvant in spray solution. The results suggested that the facilitated foliar uptake of KNF-1002 by adjuvant is also effective against strobilurin-resistant Sphaerotheca fuliginea on cucumber.

### TEST EXAMPLE 10

### Foliar Uptake of KNF-1002 into Vine Plant 24 Hours after Spraying of Aqueous Emulsion Containing Adjuvant

Vine plants (Vitis vinifera, cv. Cambell early) were propagated from woody cuttings and grown to the nine- to 10-leaf stage under glasshouse conditions. The apex and four of top immature leaves of each plant were removed before the uptake test of fungicide. Only the first and second leaves from the top were used for all tests.

KNF-1002 EC obtained in Example 3 was diluted with water. Adjuvant formulations obtained in Example 1 and an aqueous Congo Red solution as a tracer were added so that the final concentrations of adjuvant and KNF-1002 became 500 mg/l and 100 mg/l, respectively, while adjusting the Congo Red concentration to 25 mg/l. A control spray emulsion containing only KNF-1002 EC was also prepared.

Aqueous emulsions of KNF-1002 EC were sprayed onto five vine plants at a rate equivalent to 100 l/ha in a spray booth (model SP-6, 8001 EVB nozzle, R&D Sprayers Inc., USA).

Immediately after spraying, the top leaves of vine plants were cut and washed with aqueous acetonitrile solution (acetonitrile/water=7/3, v/v, 15 ml) for 2 minutes. The remainder of vine plants was stored in a dark room (temperature; 24-25° C., relative humidity; 51-61%, 74-80%), and the second leaves were washed after 24 hours.

Congo Red and KNF-1002 contents in washings were analyzed by HPLC (high performance liquid chromatography). The uptake rate of KNF-1002 was calculated in accordance with the method as described in Test example 2.

The result is shown in Table 22.

TABLE 22

| | |
|---|---|
| | Foliar uptake (%) of KNF-1002 |
| | into vine plant depending |
| Adjuvant | on relative humidity (RH) |

| formulation No. | 51-61% RH | 74-80% RH |
|---|---|---|
| LE-5 (No. A3) | 8.7 | 14.8 |
| LE-7 (No. A4) | 14.2 | 13.1 |
| LE-9 (No. A5) | 13.1 | 21.9 |
| CE-7 (No. A14) | 21.6 | 40.8 |
| CE-12 (No. A15) | 25.9 | 26.5 |
| SE-7 (No. A17) | 17.1 | 14.2 |
| SE-10 (No. A18) | 13.1 | 16.4 |
| SE-14 (No. A19) | 16.4 | 15.8 |
| OE-7 (No. A21) | 12.7 | 18.9 |
| OE-10 (No. A22) | 30.4 | 29.4 |
| PAE (No. A32) | 7.0 | 17.2 |
| STE (No. A33) | 0.5 | 1.6 |
| OLM (No. A34) | 13.5 | 2.4 |
| LIM (No. A35) | 9.0 | 6.9 |
| No adjuvant (control) | 1.9 | 2.1 |

As shown in Table 22, only 1.9-2.1% of the applied KNF-1002 was absorbed into cucumber leaves 24 hours after spraying with an aqueous emulsion in the absence of adjuvant. But the uptake could be increased up to 40.8% by adding CE-7 as an adjuvant. Uptake rate was higher under humid condition than arid condition. Uptake enhancement under the humid condition followed the general order CE-7<OE-10<CE-12.

### TEST EXAMPLE 11

### Curative Activity of KNF-1002 EC Containing Adjuvant Against Tomato Late Blight (Phytophthora infestans)

Tomato plants (Lycopersicon esculentum L, cv. Seokwang, Heungnong Seeds Co, Ltd, Korea) were grown in disposable resin pots (66 mm id×66 mm h) to the six- to seven-leaf stage under glasshouse conditions. A spore suspension of Phytophthora infestans (5×10⁴ sporangia/ml) was sprayed on the tomato plants until the leaves got sufficiently wet. The tomato plants were incubated in a humid chamber at 20° C. for 20 hours and then used to test the curative activity against tomato late blight after air-drying in the glasshouse.

The fungicidal formulation containing KNF-1002 and adjuvant (obtained in Example 2) was diluted with water to prepare a spray emulsion. A spray emulsion was also prepared with KNF-1002 EC in the absence of adjuvant.

Spray emulsions thus obtained were sprayed onto the tomato plants to run-off. The treated tomato plants were incubated in a glasshouse to induce the development of tomato late blight. The degree of infection was visually assessed five days after application. The curative activity (%) was calculated in accordance with the procedure as described in Test example 4 and the result is shown in Table 23.

TABLE 23

Curative activity (%)
of KNF-1002 against
tomato late blight

| Fungicidal formulation No. | 200 mg ai/l | 100 mg ai/l |
|---|---|---|
| LE-5 (No. F4) | 38 | 22 |
| CE-12 (No. F20) | 28 | 19 |
| SE-14 (No. F24) | 19 | 9 |
| OE-10 (No. F27) | 25 | 22 |
| No adjuvant (control) | 6 | 3 |

As shown in Table 23, the fungicidal formulation comprising the KNF-1002 and adjuvant showed significantly higher curative activity against Phytophthora infestans than KNF-1002 emulsion itself.

### TEST EXAMPLE 12

### Curative Activity of KNF-1002 EC Containing Adjuvant against Pepper Blight (Phytophthora capsici)

Pepper plants (Capsicum annunm, cv. Hyangchon, Dongbu Hannonng Seeds Co, Ltd, Korea) were grown in disposable resin pots (66 mm id×66 mm h) to the branching stage under glasshouse conditions. A spore suspension of Phytophthora capsici (5×10⁴ zoospores/ml) was sprayed on the pepper plants until the leaves got sufficiently wet. The pepper plants were incubated in a humid chamber at 20° C. for 20 hours and then used to test the curative activity against Phytophthora capsici on pepper after air-drying in the glasshouse.

The fungicidal formulation containing KNF-1002 and adjuvant (obtained in Example 2) was diluted with water to prepare a spray emulsion. A spray emulsion was also prepared with KNF-1002 EC without adjuvant.

Spray emulsions thus obtained were sprayed onto the pepper plants to run-off. The treated pepper plants were incubated in a glasshouse to induce the development of pepper blight. The degree of infection was visually assessed five days after application. The curative activity (%) was calculated in accordance with the procedure as described in Test example 4 and the result is shown in Table 24.

TABLE 24

Curative activity (%)
of KNF-1002
against pepper blight

| Fungicidal formulation No. | 200 mg ai/l | 100 mg ai/l |
|---|---|---|
| LE-5 (No. F4) | 39 | 8 |
| CE-12 (No. F20) | 37 | 0 |
| SE-14 (No. F24) | 34 | 0 |
| OE-10 (No. F27) | 11 | 6 |
| No adjuvant (control) | 2 | 3 |

As shown in Table 24, the fungicidal formulation comprising the KNF-1002 emulsion together with the adjuvant for enhancing the fungicidal efficacy showed significantly higher curative activity against Phytophthora capsici on pepper than KNF-1002 emulsion itself.

### TEST EXAMPLE 13

### Foliar Uptake of KNF-1002 into Barley Plant 24 Hours after Spraying of Aqueous Emulsion Containing Adjuvant

Barley plants (cv. Dongbori) were grown in disposable resin pots (80 mm id×80 mm h) for 45 days under glasshouse conditions.

KNF-1002 EC obtained in Example 3 was diluted with water. Adjuvant formulations obtained in Example 1 and an aqueous Congo Red solution as a tracer were added so that the final concentrations of adjuvant and KNF-1002 became 500 mg/l and 100 mg/l, respectively, while adjusting the Congo Red concentration to 25 mg/l. A control spray emulsion containing only KNF-1002 EC was also prepared.

Aqueous emulsions of KNF-1002 EC were sprayed onto ten pots of barley plants at a rate equivalent to 350 l/ha in a spray booth (model SP-6, 8001 EVB nozzle, R&D Sprayers Inc., USA).

Ten minutes after spraying, five pots of barley plants were cut and washed with aqueous acetonitrile solution (acetonitrile/water=7/3, v/v, 15 ml) for 2 minutes. The remainder of the barley plants was stored in a dark room (temperature; 24-25° C., relative humidity; 80-85%), and washed after 24 hours.

Congo Red and KNF-1002 contents in washings were analyzed by HPLC (high performance liquid chromatography). The uptake rate of KNF-1002 was calculated in accordance with the method as described in Test example 2.

The result is shown in Table 25.

TABLE 25

| | Foliar uptake of KNF-1002 |
|---|---|
| Adjuvant formulation No. | into barley plant (%) |
| LE-5 (No. A3) | 28.4 |
| LE-7 (No. A4) | 37.1 |
| LE-9 (No. A5) | 35.6 |
| IDE-5 (No. A7) | 21.6 |
| IDE-7 (No. A8) | 28.9 |
| TDE-5 (No. A10) | 19.0 |
| TDE-7 (No. A11) | 27.0 |
| TDE-10 (No. A12) | 31.0 |
| CE-7 (No. A14) | 43.7 |
| CE-12 (No. A15) | 46.4 |
| SE-7 (No. A17) | 21.4 |
| SE-10 (No. A18) | 31.6 |
| SE-14 (No. A19) | 37.6 |
| OE-7 (No. A21) | 48.5 |
| OE-10 (No. A22) | 43.6 |
| RPE-8020 (No. A26) | 1.8 |
| SDSS (No. A30) | 3.0 |
| PAE (No. A33) | 9.0 |
| OLM (No. A35) | 12.3 |
| LIM (No. A36) | 11.4 |
| No adjuvant (Control) | 0.1 |

As shown in Table 25, only 0.1% of the applied KNF-1002 was absorbed into barley plants 24 hours after spraying with an aqueous emulsion in the absence of adjuvant. But the uptake could be increased up to 48.5% by adding adjuvant. Uptake enhancement followed the general order OE-7<CE-12<CE-7=OE-10.

### TEST EXAMPLE 14

### Foliar Uptake of KNF-1002 into Wheat Plant 24 Hours after Spraying of Aqueous Emulsion Containing Adjuvant

Wheat plants (cv. Dahongmil) were grown in disposable resin pots (105 mm id×100 mm h) for 45 days under glasshouse conditions.

KNF-1002 EC obtained in Example 3 was diluted with water. Adjuvant formulations obtained in Example 1 and an aqueous Congo Red solution as a tracer were added so that the final concentrations of adjuvant and KNF-1002 became 500 mg/l and 100 mg/l, respectively, while adjusting the Congo Red concentration to 25 mg/l. A control spray emulsion containing only KNF-1002 EC was also prepared.

Aqueous emulsions of KNF-1002 EC were sprayed onto 15 pots of wheat plants at a rate equivalent to 350 l/ha in a spray booth (model SP-6, 8001 EVB nozzle, R&D Sprayers Inc., USA).

Ten minutes after spraying, five pots of wheat plants were cut and washed with aqueous acetonitrile solution (acetonitrile/water=7/3, v/v, 15 ml) for 2 minutes. The remainder of the wheat plants was stored in a dark room (temperature; 24-25° C., relative humidity; 51-60%, 75-80%), and washed after 24 hours.

Congo Red and KNF-1002 contents in washings were analyzed by HPLC (high performance liquid chromatography). The uptake rate of KNF-1002 was calculated in accordance with the method as described in Test example 2.

The result is shown in Table 26.

TABLE 26

Foliar uptake (%) of
KNF-1002 into wheat plant
depending on relative
humidity (RH)

| Adjuvant formulation No. | 51-60% RH | 75-80% RH |
|---|---|---|
| LE-5 (No. A3) | 13.9 | 19.6 |
| LE-7 (No. A4) | 16.1 | 21.6 |
| LE-9 (No. A5) | 25.7 | 20.7 |
| IDE-5 (No. A7) | 14.8 | 10.8 |
| IDE-7 (No. A8) | 15.7 | 17.1 |
| TDE-5 (No. A10) | 10.6 | 12.1 |
| TDE-7 (No. A11) | 16.4 | 12.6 |
| TDE-10 (No. A12) | 14.7 | 15.2 |
| CE-7 (No. A14) | 46.1 | 37.3 |
| CE-12 (No. A15) | 42.3 | 41.4 |
| SE-7 (No. A17) | 44.3 | 28.0 |
| SE-10 (No. A18) | 31.6 | 29.8 |
| SE-14 (No. A19) | 43.8 | 36.5 |
| OE-7 (No. A21) | 22.2 | 23.7 |
| OE-10 (No. A22) | 19.3 | 31.7 |
| RPE-8020 (No. A26) | 2.5 | 4.1 |
| SDSS (No. A30) | 4.9 | 0.2 |
| PAE (No. A33) | 1.6 | 3.5 |
| OLM (No. A35) | 8.0 | 1.6 |
| LIM (No. A36) | 2.8 | 5.8 |
| No adjuvant (Control) | 0.0 | 0.0 |

As shown in Table 26, none of the applied KNF-1002 was absorbed into barley plants 24 hours after spraying of an aqueous emulsion in the absence of adjuvant. But the uptake could be increased up to 46.1% by adding adjuvant. The more effective adjuvants for promoting the foliar uptake of KNF-1002 into wheat plants were CE, SE, OE and LE, etc.

### TEST EXAMPLE 15

### Foliar Uptake and Spray Deposition of KNF-1002 by Adjuvant

The preparation procedure of wheat plant, spray emulsion and the spray application onto wheat plants were conducted as the same method as described in Test example 14.

Ten minutes after spraying, five pots of wheat plants were cut and washed with aqueous acetonitrile solution (acetonitrile/water=7/3, v/v, 15 ml) for 2 minutes. The remainder of the wheat plants was stored in a dark room (temperature; 24-25° C., relative humidity; 78-80%), and washed after 24 hours.

Congo Red and KNF-1002 contents in washings were analyzed by HPLC. The uptake rate of KNF-1002 was calculated in accordance with the method as described in Test example 2. And the spray deposit of KNF-1002 on wheat plant was calculated as a ratio of Congo Red concentration in leaf washing obtained from the application of emulsion containing adjuvant to that in leaf washing of control.

The result is shown in Table 27.

TABLE 27

| Adjuvant formulation No. | Foliar uptake (%) | Spray deposit^{a} (%) |
|---|---|---|
| LE-5 (No. A3) | 16.7 | 1.59 |
| LE-7 (No. A4) | 20.5 | 1.77 |
| LE-9 (No. A5) | 20.4 | 1.75 |
| LE-20 (No. A6) | 16.2 | 1.73 |
| IDE-7 (No. A8) | 14.9 | 1.80 |
| TDE-7 (No. A11) | 13.0 | 1.88 |
| CE-12 (No. A15) | 40.0 | 1.14 |
| SE-14 (No. A19) | 39.7 | 0.96 |
| OE-7 (No. A21) | 37.8 | 1.08 |
| OE-10 (No. A22) | 32.2 | 1.14 |
| PE-61 (No. A24) | 2.9 | 1.59 |
| PE-74 (No. A25) | 1.7 | 1.66 |
| RPE-8020 (No. A26) | 1.0 | 1.96 |
| SDSS (No. A30) | 1.0 | 2.11 |
| No adjuvant (control) | 2.4 | 1.00 |

^{a}ratio of Congo Red concentration in leaf washing obtained from the application of emulsion containing adjuvant to that in leaf washing of control

As shown in Table 27, the fungicidal formulation of KNF-1002 containing adjuvant showed significantly higher foliar uptake rate and deposition ratio than those of KNF-1002 emulsion itself.

### TEST EXAMPLE 16

### Fungicidal Activity of KNF-1002 EC Containing Adjuvant Against Barley Powdery Mildew

Barley plants were grown in disposable resin pots (105 mm id×100 mm h) for 45 days under glasshouse conditions, infected with Erysiphe graminis f. sp. Hordei naturally.

The fungicidal formulation containing KNF-1002 and the adjuvant for enhancing the fungicidal efficacy (obtained in Example 2) was diluted with water to prepare a spray emulsion. A control spray emulsion containing only KNF-1002 EC was also prepared.

Aqueous emulsions of KNF-1002 EC were sprayed onto five pots of barley plants at a rate equivalent to 333 l/ha, 111 l/ha and 37 l/ha in a spray booth (model SP-6, 8001 EVB nozzle, R&D Sprayers Inc., USA), respectively.

Incidence of powdery mildew was visually assessed 12 days after spraying. The fungicidal activity (%) was calculated in accordance with the procedure as described in Test example 4 and the result is shown in Table 28.

TABLE 28

| | Fungicidal activity (%) | | |
|---|---|---|---|
| | against barley powdery | | |
| | mildew depending on | | |
| | spray volume (l/ha) | | |
| Fungicidal formulation No. | 333 | 111 | 37 |
| KNF-1002 + LE-9 (1:8) | 68 | 36 | 18 |
| (No. F10) | | | |
| KNF-1002 + LE-9 (1:4) | 70 | 50 | 22 |
| (No. F9) | | | |
| KNF-1002 + LE-9 (1:2) | 64 | 31 | 16 |
| (No. F8) | | | |
| KNF-1002 + LE-9 (1:1) | 32 | 14 | 14 |
| (No. F7) | | | |
| No adjuvant (control) | 9 | 2 | 0 |

As shown in Table 28, the fungicidal formulation comprising the KNF-1002 and adjuvant for enhancing the fungicidal efficacy, especially at the ratio of 1:4 by weight, showed significantly higher fungicidal activity against barley powdery mildew than KNF-1002 alone.

### TEST EXAMPLE 17

### Fungicidal Activity of KNF-1002 EC Containing Adjuvant Against Barley Powdery Mildew

Barley plants (cv. Winter barley) were grown in disposable resin pots (105 mm id×100 mm h) for 45 days under glasshouse conditions, infected by powdery mildew (Erysiphe graminisf sp. hordei) naturally.

The fungicidal formulation containing KNF-1002 and adjuvant for enhancing the fungicidal efficacy, obtained in Example 2, was diluted with water to prepare an fungicidal solution containing KNF-1002 50 mg/l and adjuvant 200 mg/l. A control spray emulsion containing only KNF-1002 EC was also prepared.

Aqueous emulsions of KNF-1002 EC were sprayed onto five pots of barley plants at a rate equivalent to 111 l/ha in a spray booth (model SP-6, 8001 EVB nozzle, R&D Sprayers Inc., USA).

Spotted area by powdery mildew was visually assessed 12 days after spraying. The fungicidal activity (%) was calculated in accordance with the procedure as displayed in Test example 4 and the result is shown in Table 29.

TABLE 29

| | Fungicidal activity against barley |
|---|---|
| Fungicidal formulation No. | powdery mildew (%) |
| LE-5 (No. F4) | 24 |
| LE-7 (No. F6) | 42 |
| LE-9 (No. F9) | 50 |
| LE-20 (No. F11) | 48 |
| IDE-7 (No. F13) | 58 |
| TDE-7 (No. F16) | 55 |
| CE-7 (No. F19) | 45 |
| CE-12 (No. F20) | 50 |
| SE-14 (No. F24) | 29 |
| OE-10 (No. F27) | 9 |
| PE-74 (No. F30) | 33 |
| SDSS (No. F36) | 28 |
| No adjuvant (control). | 2 |

As shown in Table 29, the fungicidal formulation comprising the KNF-1002 and adjuvant showed significantly higher fungicidal activity against barley powdery mildew than KNF-1002 alone.

While the invention has been described with respect to the above specific embodiments, it should be recognized that various modifications and changes may be made to the invention by those skilled in the art which also fall within the scope of the invention as defined by the appended claims.

What is claimed is

1. The fungicidal composition, which comprises:
(i) an agrochemical selected from the group consisting of methyl (2E)-3-methoxy-2-[2′-[[[3″-(1″-fluoro-2′″-phenyl-1′″-ethenyloxy)phenyl]methylimino]oxy]methylphenyl]propenoate of formula (I); N-methyl (2E)-2-methoxyimino-2-[2′-[[[3″-(1′″-fluoro-2′″-phenyl-1′″-ethenyloxy)phenyl]methylimino]oxy]methylphenylacetamide of formula (II) and a mixture thereof, and
(ii) an adjuvant for enhancing the fungicidal efficacy, selected from the group consisting of: a nonionic surfactant selected from the group consisting of polyoxyethylene alkyl ether, polyoxyethylene alkyl ester, ethoxylated caster oil, polyoxyethylene-polyoxypropylene block copolymer and a mixture thereof; an anionic surfactant selected from the group consisting of sodium dioctyl sulfosuccinate, sodium dodecylbenzenesulfonate and a mixture thereof; and a fatty acid alkyl ester;
said agrochemical and said adjuvant for enhancing the fungicidal efficacy being mixed in a ratio range from 1:0.5 to 1:20 by weight.

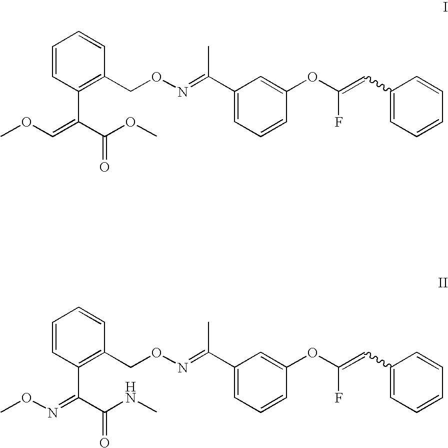

2. The composition of claim 1, wherein the adjuvant for enhancing the fungicidal efficacy is selected from the group consisting of a nonionic surfactant selected from the group consisting of a polyoxyethylene-based nonionic surfactants which has an aliphatic alcohol, a fatty acid or triacyl glyceride as a lipophilic moiety containing at least 8 carbon atoms and a polyoxyethylene as a hydrophilic moiety having 3 to 25 oxyethylene repeating units; a polyoxyethylene-polyoxypropylene block copolymer containing 2 to 40 oxyethylene and 25 to 45 oxypropylene repeating units and a mixture thereof; an anionic surfactant selected from the group consisting of sodium dioctyl sulfosuccinate, sodium dodecylbenzenesulfonate and a mixture thereof; and fatty acid alkyl esters having at least 14 carbon atoms;

3. The composition of claim 1, which further comprises another agrochemical for preventing or treating plant diseases.

4. An adjuvant composition for enhancing the fungicidal efficacy of an agrochernical of compound of formula (I) or (II) against plant diseases, which comprises;
(a) an effective amount of one or more adjuvants for enhancing the fungicidal efficacy selected from the group consisting of a polyoxyethylene-based nonionic surfactants which has an aliphatic alcohol, a fatty acid or triacyl glyceride as a lipophilic moiety containing at least 8 carbon atoms and a polyoxyethylene as a hydrophilic moiety having 3 to 25 oxyethylene repeating units; a polyoxyethylene-polyoxypropylene block copolymer containing 2 to 40 oxyethylene and 25 to 45 oxypropylene repeating units and a mixture thereof; an anionic surfactant selected from the group consisting of sodium dioctyl sulfosuccinate, sodium dodecylbenzenesulfonate and a mixture thereof; and fatty acid alkyl esters having at least 14 carbon atoms;
(b) an emulsifier or dispersant; and
(c) a carrier.

5. A method for preventing or treating a plant disease, which comprises spraying the composition of any one of claims 1 to 5 at a concentration of 4 to 400 mg/l of the agrochemical or 50 to 2,000 mg/l of the adjuvant for enhancing the fungicidal efficacy to said plant.
